(19) United States
(12) Patent Application Publication
(10) Pub. No.: US 2002/0106998 A1
(43) Pub. Date: Aug. 8, 2002

(54) Wireless rich media conferencing

(76) Inventors: Herbert L. Presley, Jacksonville, FL (US); Randall K. Walker, Sour Lake, TX (US)

Correspondence Address: Mark J. Young, McGuireWoods LLP, Suite 3300, 50 North Laura Street, Jacksonville, FL, 32202, US

(21) Appl. No.: 10/068,638

(22) Filed: Feb. 6, 2002

Related U.S. Application Data
(60) Provisional application No. 60/266,818, filed on Feb. 5, 2001.

(51) Int. Cl. H04Q 7/20

(52) U.S. Cl. 455/403; 455/561

(57) ABSTRACT

A wireless conferencing system for interactive rich media communication includes one or more transceivers that acquire, transmit, receive and display audio and video data using a wireless information exchange protocol. Optionally, a central server processes, coordinates and manages the wireless information exchanged among multiple transceivers. Software components provide rich media conferencing utility for a variety of uses, including judicial, law enforcement, medical, and military applications.

### CLAIM OF PRIORITY BASED ON PROVISIONAL APPLICATION

This application claims priority to U. S. Provisional Application 60/266,818, filed Feb. 5, 2001, the entire contents of which are hereby incorporated by reference herein.

### FIELD OF THE INVENTION

The present invention relates to the field of wireless rich media conferencing. More specifically, the present invention is directed to a wireless communications system for rich media directed at reducing the cost and expanding the utility of prior art systems in several vertical applications.

### BACKGROUND OF THE INVENTION

The exchange of video and audio (collectively “rich media,” which may also include graphics and other data) among conferees has many useful applications but also high processing and infrastructure requirements. In particular, rich media conferencing requires high throughput, making it unsuitable for several common but low bandwidth solutions such as POTS or wireless connections. For purposes of the present invention, the term “conference” simply means the exchange of information between two end devices. Typically, rich media conferencing is performed over dedicated high-speed networks or high bandwidth channels, both of which are expensive to install and maintain. Further, in many situations, the use of any wired infrastructure at all is prohibitive.

In the judicial system, the use of rich media conferencing in the courtroom can potentially reduce costs, promote safety, and promote accuracy of records. Prisoners giving their testimony interactively through a videoconference would no longer need to be transported to the courthouse to testify, thereby eliminating transportation costs as well as risks inherent in moving prisoners. Further, witnesses giving testimony via interactive videoconference would no longer need to travel to the courtroom, eliminating both the cost and burden on the witness. Still further, transcription errors inherent with the use of a court reporter may be reduced through the use of a recordation system (onto a video or audio magnetic tape storage media or a digital storage device).

Unfortunately, the cost for implementing such a system using traditional technology is often prohibitive. Much of this high cost can be attributed to infrastructure: wiring a courthouse for closed circuit television can cost on the order of hundreds of thousands of dollars. For example, though videoconferencing systems adapted for courtroom use have been developed, see U.S. Pat. No. 5,382,972, issued Jan. 17, 1995 to Kannes; and U.S. Pat. No. 4,965,819, issued Oct. 23, 1990 to Kannes, they require extensive infrastructure to install and maintain, putting them out of the reach of many jurisdictions.

### SUMMARY

The present invention provides a wireless rich media conferencing system including one or more transceivers that record, acquire, transmit, receive, display and play rich media, including audio, video, textual and graphical data over a wireless information exchange protocol. Optionally, the system may also include a central server that processes and manages the data exchanged among multiple transceivers. Software components may be included to optimize the system for a variety of uses, including judicial, law enforcement, medical, and military applications. Cost savings due to the lack of need for a wire infrastructure and portability of the transceivers are key advantages of the wireless videoconferencing system.

It is therefore an object of the present invention to provide a wireless rich media conferencing system including one or more transceivers that record, acquire, transmit, receive, display and play rich media, including audio, video, textual and graphical data over a wireless information exchange protocol.

It is also an object of the present invention to provide a wireless rich media conferencing system including one or more wireless transceivers and one or more wired transceivers that record, acquire, transmit, receive, display and play rich media, including audio, video, textual and graphical data over a wireless information exchange protocol.

It is another object of the present invention to provide a wireless rich media conferencing system including a server communicatively coupled with one or more transceivers to facilitate wireless rich media conferencing.

It is yet another object of the present invention to provide a wireless rich media conferencing system that substantially reduces or eliminates the need for network wiring of a facility.

It is a further object of the present invention to provide a wireless rich media conferencing system that is portable.

It is still a further object of the present invention to provide a wireless rich media conferencing system that is adaptable to accommodate a wide variety of vertical applications.

### BRIEF DESCRIPTION OF THE DRAWINGS

The foregoing and other objects, features and advantages of the present invention will become better understood with reference to the following description, appended claims, and accompanying drawings, where:

FIG. 1 is a high level block diagram conceptually displaying components of an exemplary transceiver in accordance with a preferred implementation of the present invention; and

FIG. 2 is a high level block diagram conceptually displaying an exemplary network including a wireless rich media conferencing system in accordance with a preferred implementation of the present invention.

### DESCRIPTION OF THE INVENTION

The present invention addresses the aforementioned shortcomings of the prior art. Through the use of wireless video and audio exchange between the conferee units and a central unit, the present invention overcomes the infrastructure limitations and provides users with a wide array of capabilities that may be adapted to various uses, including courtroom, law enforcement, medical, and military use.

The present invention is generally directed to the field of wireless rich media conferencing. More specifically, the present invention is directed to a wireless communications system for rich media directed at reducing the cost and expanding the utility of prior art systems in several vertical applications.

Advantageously, the present invention provides the benefits of rich media conferencing without having to incur the considerable expense of installing a wired infrastructure. This is particularly useful in field applications such as crime scenes, remote detention facilities, or battlefields where the underlying infrastructure is likely lacking. In addition, the present invention allows for a much greater degree of portability.

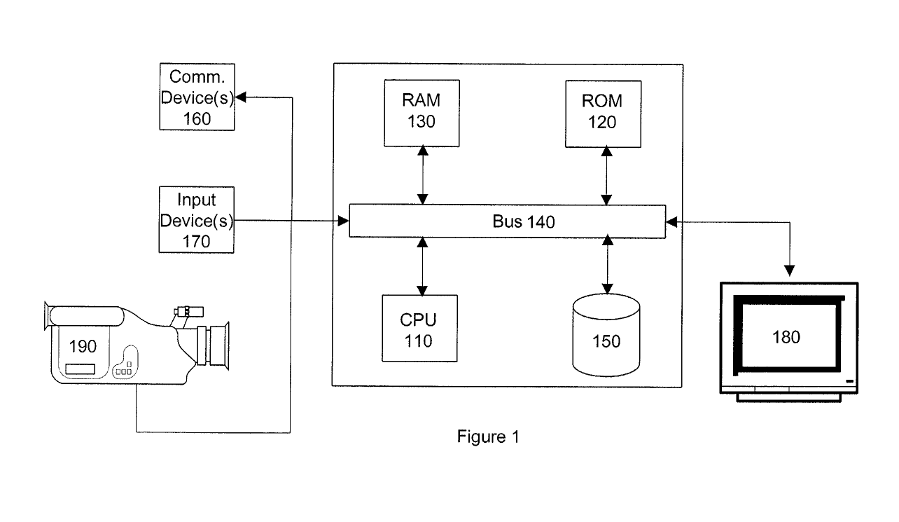

FIG. 1 conceptually shows an exemplary transceiver computer system (“transceiver”) for implementing a system and methodology to facilitate wireless rich media conferencing in accordance with a preferred implementation of the present invention. The transceiver includes a bus 140 for communicating information, a central processing unit (CPU) 110, a read only memory (ROM) 120, random access memory (RAM) 130, a storage device 150, a communications device 160, an input device 170, a display monitor 180 and a digital video recorder 190. The storage device may include a hard disk, CD-ROM drive, tape drive, memory and/or other mass storage equipment. The input device may include a microphone, keyboard, writing tablet, pointing device, and/or any other device capable of providing input signals. The communications device provides wireless (e.g., cellular, fixed wireless or RF) communication.

The aforementioned transceiver is intended to functionally represent a broad category of computer systems capable of being configured and programmed to provide wireless rich media conferencing in accordance with a preferred implementation of the present invention. The specific configuration or implementation is a design decision that may vary based on several factors including the desired type and environment of use, and characteristics of the target user. Thus, the system may take various forms, including a desktop, laptop, server, client, thin client or handheld computer system, each of which may include the preferred elements 110 through 190 in various sizes and configurations. Of course, the system may also include fewer, different and/or additional components and peripherals, provided it is capable of facilitating wireless rich media conferencing in accordance with a preferred implementation of the present invention.

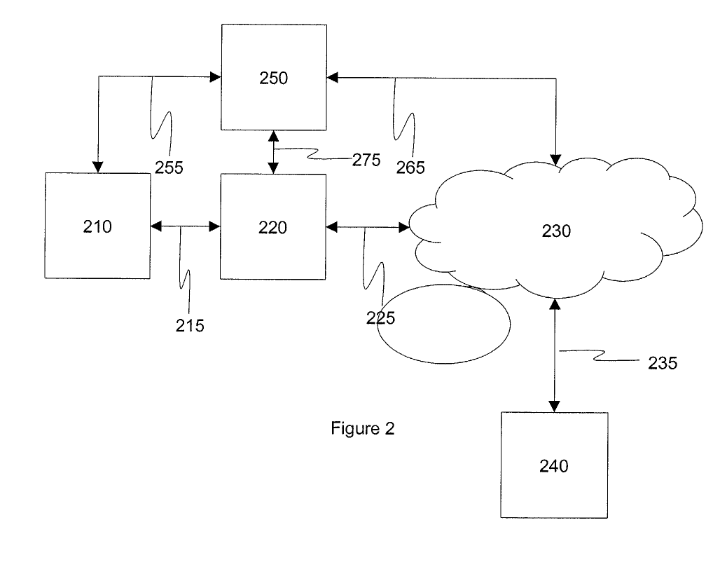

Referring to FIG. 2, a system of the present invention comprises a wireless transceiver 210 operatively coupled to a second transceiver 240, which may or may not be wireless. As used in this disclosure, “operatively coupled” means connected in such a way that data may be exchanged. It is understood that “operatively coupled” does not require a direct connection or a even permanent connection. It is sufficient that the connection(s) be established for the sole purpose of exchanging information. In alternate embodiments, the system may also include a central server operatively coupled to each of the transceivers. As discussed in more detail below, the central server may provide additional functionality to the system.

The transceivers and a central server each includes a hardware component, which is typically a computing device, and a software component configured to execute thereon. The term “computing device” is used broadly to mean a microprocessor-based device operable to execute software instructions. Examples include, without limitation, personal computers (PCs), notebook computers, palmtop computers, network computers, network terminals, personal digital assistants (PDAs), Internet appliances, wireless devices, game consoles, and television set-top boxes.

In addition, each transceiver further comprises a display component for displaying rich media, a recorder component for acquiring and digitizing rich media, and a communications component for transmitting and receiving rich media. The specific implementation of a transceiver device is a design decision that may be driven by logistical and design constraints such as cost, screen size or desired portability of the unit, and may include many devices ranging from a PC with a camera and microphone to a television, video camera, and wireless modem to a conventional PDA. Display components may include, but are not limited to, a flat panel display, a laptop computer display, a PDA display, and the related software. Recorder components may include, but are not limited to, a digital camera, an analog camera, a microphone, and the related software. Communications components may include, but are not limited to, an analog modem, a wireless modem, and ISDN modem, a network interface card, and the related software. The choice of any one particular implementation of a transceiver, including the specific components comprised therein, is within the scope of one skilled in the art and is not limited by the present invention.

With respect to the wireless transceiver, its communication component 160 transmits and receives information wirelessly using any available wireless information exchange means and protocols. While current wireless exchange protocols are sufficient to support the bandwidth needs for certain uses contemplated by the present invention, the present system is compatible with the additional functionality and performance brought about with the advancement of wireless exchange protocols.

In addition, software and/or hardware providing data compression functionality may allow for improved frame rates and quality when used in conjunction with current or future protocols. In some embodiments, the transceiver may include an encoding module for encoding signals, allowing for lower-bandwidth transmissions. Various coding standards may be applied to communicate video data. These standards include Motion Pictures Experts Group (“MPEG”)-1 for CD-ROM storage, MPEG-2 for DVD and DTV applications and H.261/263 for video conferencing. For distribution to the home, a growing consensus favors MPEG coding, currently MPEG-4 coding in particular. For other parts of the distribution chain, e.g., acquisition, post-production and archiving, there are a multitude of different formats. These coding standards substantially compress video data to reduce the amount of bandwidth required for network transmission and space required for storage. The use of current compression algorithms such as MPEG4 and related software and/or hardware is contemplated by the present invention as well as any improvements and future advances.

In an illustrative embodiment, wireless transceiver 210 is communicatively coupled through a wireless communication means (a “gateway”) 215 and wireless base station 220 (e.g., a cellular base station) to a network such as the Internet 230, which is communicatively coupled to a one or more other transceivers 240 through a wired communication means or a similar wireless gateway 235 and base station. In other embodiments, local area networks, corporate intranets, or other private networks may be used instead of or in addition to the Internet 230. However, the use of a global network such as the Internet provides convenience and reliability that is difficult to duplicate with private, localized networks.

In an alternative embodiment, one or more of the transceivers (e.g., 210) may be communicatively coupled to a local access point, i.e., a wireless to wired bridge for receiving and transmitting data to and from one or more local wireless transceivers and for communicating such data using a conventional wired network. Such access points, which may function as the base station 220, may include devices in conformance with IEEE wireless-Ethemet specifications (e.g., IEEE 802.11), Home RF, Shared Wireless Access Protocol (SWAP), Digital Enhanced Cordless Telecommunications (DECT), Wireless Fidelity (Wi-Fi), or other standards and protocols. Illustratively, an ISB Wavebase by Nexland or a 3Com Airconnect wireless system may serve as a local access point, bridging one or more local transceivers to a high speed wired (which may include optical) network connection.

In operation, the wireless transceiver connects to the other transceiver through a directory, using a network identifier or address, or through any of several other means known in the art to establish a communications link. If desired, the identity of the user of each transceiver is authenticated (e.g., with a username/password combination). Also, if desired, security measures and/or encryption may be used. Once the communications link is established, the transceivers can transmit and receive rich media in addition to performing any of the other functions provided in the software components.

In some embodiments, the system may include a central server 250 which communicates directly (e.g., via wireless communications means 255) or indirectly (e.g., via wired communications means 265 and/or 275) with one or more transceivers, which may include both wired and wireless transceivers. The central server 250 may be used to facilitate the connection of transceivers (e.g., by maintaining a directory), to send out software upgrades, to record rich media, and in some cases to act as an application service provider for some or all of the functionality available to the transceivers. The central server 250 may thus provide robust processing and storage capabilities to facilitate wireless rich media conferencing.

Software in the transceivers and, in a preferred embodiment, the central server generally functions to enable and coordinate communications, allow interaction, and provide application-specific enhanced features. For example the transceiver 210 and central server 250 may use software to convert the acquired audio and/or video data into a format capable of being transmitted wirelessly. Software in the transceiver or central server may compress and decompress data to allow increased frame rate transmission. Software in the transceiver may enable a conferee to interact with the central server or other conferees. Software in the transceiver or central server may support the display of certain types of application-specific documents, photographs, or audio and video clips. Advantageously, the software component of the transceivers and central server (if present) may be configured to tailor the capabilities of the system to a particular application.

The use of both off-the-shelf and custom software applications is contemplated by the present invention. Further, the scope of the present invention is not limited to or tied to any particular software or hardware platform or implementation. Any of a number of software development tools may be used to create the software portions of the present invention. Examples include, without limitation, Director™, Toolbook™, and Authorware™ to create the rich, multimedia interfaces, and Java™, WebSphere™ or Microsoft ASP™ for network-based tools.

In some embodiments, the wireless transceiver may be handheld, such as a personal digital assistant. This, combined with the convenience provided by having a wireless connection to the network provides an great degree of freedom. However, for purposes of the present invention, the wireless transceiver is not required to be handheld. In some instances, a non-handheld implementation such as a laptop or personal computer may be desirable, avoiding the power and display-size limitations that are present with handheld devices. One example of a non-handheld embodiment is a car-mounted computing device.

The central server may include one or more software applications executing on one or more computing devices configured to provide the functionality described herein. The present invention contemplates any of several different configurations for the central server. The use of any one particular is a design decision that may be based upon several factors not limited by the present invention. Illustratively, the central server may include a single or multiple Intel Pentium III, IV, Xenon (or future generation) or comparable AMD Athlon-based computer running Windows NT, Windows 2000, Linux or UNIX. The computing unit chosen for the central server may vary based on desired functionality. For example, in one embodiment each transceiver may be equipped with central server functionality allowing the transceivers to communicate directly with each other. In another embodiment, the central server may be a computer or network of computers. A single central server with sufficient processing and communications capability may coordinate multiple groups of transceivers, allowing a single central server to conduct multiple rich media conferences simultaneously. The central server may be equipped with all of the components conceptually shown in FIG. 1 for a transceiver (except, perhaps, for the video recorder 190), including communication hardware, communication software, recordation functionality, encoding software such as a CODEC, and application-specific software.

In operation, the client transceiver may establish a connection with the central server through a communication means. After a connection is established there is typically an authentication step to verify the identity of the transceiver, and a security step to verify that the transceiver has access. Any of the known authentication and security techniques are contemplated by the present invention as well as improvements and future techniques. Further, the use of secure and/or encrypted transmission are contemplated.

The central server as well as the transceivers may be configured to provide recordation capability. However, particularly with a handheld transceiver that may have limited storage, the central server may be better suited to maintain a library of rich media recordings. A broad range of options is contemplated by the present invention to provide recordation capability. For example, the central server may convert the video and audio signals into NTSC format for recording with a conventional VCR, or the central server may record the video and audio signals as digital information on an optical or magnetic data storage medium. The recordation capability may include software to archive the various records. Records from the archives may then be copied and distributed to requesting conferees.

In alternative embodiments, the client transceivers are “thin” clients that require very little local storage and processing power, with both the data and applications stored on the network, for example at the central sever. The transceiver would receive all screen displays from the central server, acting as an application service provider, rather than generating it for itself. Advantages include: complete centralized control of the application, real-time updates to user interfaces and application feature sets; real-time mass customization for multiple clients, disadvantages include: higher bandwidth requirements; likely application latency; dependency on network “uptime”.

The functionality described in the following vertical applications of the system of the present invention may be implemented by tailoring the software in each of the components accordingly. In a preferred implementation, the vertical applications (each for performing a “process”) include means for playing and displaying streaming and downloaded rich media content, including video, still images, audio, graphics, documents, and textual data, as well as means for managing the creation, storage and transmission of such content using conventional hardware and software for accomplishing such steps. Each of the various components or types of content may be displayed in a determinable area or window, allowing layering, tiling, cascading, sizing and selecting windows to suit a user's preferences and limit display clutter. In a particular preferred implementation, the vertical applications may be configured or tailored to provide areas or windows to accommodate the desired content for a particular application. Thus, for example, a telemedicine application may include windows for displaying streaming video, patient related documents and real-time or stored graphical representations or textual information concerning the patient's condition (e.g., temperature, pulse rate, blood pressure, etc...). In contrast, a legal or judicial application may be configured quite differently, with fewer or additional windows for presenting various forms of rich media to facilitate pertinent conference.

Judicial Use

Videoconferencing through closed-circuit television has been successfully used in several jurisdictions. However, the expense of the necessary infrastructure has precluded several poorer and rural areas from making use of rich media conferencing. The present invention allows these areas to do so, as described below.

One application of the system described above is in judicial hearings. For example, the present invention may be used to conduct a live, interactive arraignment of a prisoner without the costs and risks of transporting the prisoner. With respect to arraignments, when someone is arrested by law enforcement officials for any offense, when they are booked into jail, the officer presents him or her with a valid warrant for their arrest, or a probable cause affidavit along with a formal complaint accusing the offender of what law or laws that he or she has broken. At this point the accused is booked into the jail or holding facility. Shortly thereafter, the accused is arraigned.

An arraignment is a hearing where a defendant is advised of the formal charges filed by the State and allowed to enter a plea as to the charges. A magistrate or judge reviews the complaint or probably cause affidavit to make sure there are no mistakes, which could lead to the defendant being released. If the paperwork is in order, the magistrate or judge would advise the defendant of his/her Miranda rights and advise them what they are charged with. After doing so, the magistrate or judge sets bail for them, so that they may be released.

If the accused has an attorney, he may enter a written plea in behalf of the accused and waive the accused's appearance at the arraignment. If not, the accused must appear. Whenever an arraignment is conducted, a jailer or other correctional officer must bring the defendant before the magistrate or judge. With the prisoner remaining in the confines of jail, the prisoner does not have to be restrained, and transported to appear before the court. Risk to officers transporting and standing with the defendant are reduced as well as the risk of inmates escaping. Further, the number of cases heard each day may be increased.

Alternatively, the judge or magistrate travels to the jail or holding facility. The drawbacks to jail visits are the travel time and expenses, and safety factors. For example, the outer jail or correctional facility door must be opened to admit court personnel. Further, court personnel are in danger from assault from some defendants, e.g., violent, and/or mentally ill defendants.

Software on the central server or transceiver could be configured to provide enhanced functionality for judges, lawyers and other participants in the arraignment process. For example, the judge may be able to request and view the complaint, criminal history, affidavits, and state and federal laws on his or her transceiver, while the defendant's transceiver may display an arraignment sheet or ruling sheet. The data requested by the conferees may be stored in the transceivers themselves, in the central server, or on a computer or network of computers (which may be accessed by the central server and transmitted to the transceiver). The software may also allow a judge to store information in a file dedicated to the docket number of a particular case. Likewise, the software may allow attorneys to file affidavits and other court documents into a file dedicated to the docket number. In some embodiments, the software may feature a text to speech editor to read the relevant provisions of law or other documents from the file. Further, the communications software in the transceivers or central control unit may be configured to provide a “silent” mode to allow a senior attorney to remain in his office and monitor a court proceeding, and only communicate with the transceiver used in court by an attorney from the same firm.

In another application of the present invention, the system could be used to facilitate the deposition of remote witnesses. Advantageously, the witness would not incur the costs and burdens associated with traveling. Software in the transceivers or central server may be configured to allow a conferee's transceiver device to display relevant documents interactively. Further, a record of the deposition could automatically be generated, stored, and even forwarded to the court.

Though generally secured transmissions are not necessary with arraignments, other public judicial hearings, and depositions, in some instances a secure environment may be desirable. Thus, as described above in more detail the system contemplates the use of security and encryption procedures that are well within the skill of one skilled in the relevant art.

Law Enforcement

The flexibility provided by the wireless transceivers in the present invention lends itself to a range of uses in law enforcement. Even with an unlimited budget, many law enforcement applications simply do not lend themselves to a wired infrastructure.

For example, the system may be used to aid police officers in a traffic stops. Currently, video and audio recordings made from a police cruiser remain in the car, subject to damage or theft. The present invention may be used to transmit this audio and video data to a central site for archiving, thus eliminating the aforementioned risks. In addition, current video systems provide little assistance to the officer during the stop. On the other hand, with the present system, a wireless transceiver could be mounted in the car, powered by the car's electrical system, which could record the traffic stop and send the video of the stop to another officer or dispatcher to watch for any malfeasance. In the event that something happens to the officer, and he or she is unable to radio for help, the department would know to send assistance by virtue of the present system. Further, the transceiver could be integrated with the existing police computer systems to deliver other data such as license plate number, arrest warrants, or suspect identification along with the video. Still further, the dispatch could send pictures or video of wanted criminals and suspects to verify identification or issue “APB's”. In alternate embodiments, a handheld transceiver could be carried by the officer during to provide the same functionality.

Further, the aforementioned embodiment could be utilized in traffic pursuits. In particular, the pursuing officer could use the transceiver to send a picture of the chased car, its license plate, and any landmarks that are passed, allowing the officer to concentrate on following the suspect instead of talking with the dispatch.

Moreover, a device may be included to signal an emergency. The device may communicate a wireless RF signal to a receiver in a patrol car. The device may be manually activated, bio-electrically activated (e.g., based on a measured pulse) and/or activated upon the occurrence of certain events (e.g., removing a firearm from a holster or firing the firearm). Upon receipt of such signal, the receiver may cause a patrol car transceiver and/or a handheld transceiver to send identification and location information, and/or video data to a dispatch transceiver for immediate emergency assistance. Those skilled in the art will appreciate that the aforementioned device may be applied in various other applications including medical applications for purposes of monitoring a patient's vital signs, security applications for purposes of monitoring a secure facility, and other applications where rich media data (including video data) may help in formulating an appropriate response to a monitored event or emergency. Those skilled in the art will also appreciate that the device may include a wired connection to the transceiver in certain applications, such as patient monitoring. Such alternative applications and connections clearly come within the scope of the present invention.

In another application, the present system may be utilized to enhance crime scene investigation. In particular, the transceiver can be used in the evidence gathering stage. Pictures and video of the crime scene, its contents, and the collection of any evidence can be sent to a secure server where it can be logged and stored. Later the stored rich media records may be used to help authenticate the evidence and evidence-gathering procedures which were used. In addition, the present system may be used for on-site interviewing and interrogation. In addition to the recordation functionality, the present system would be useful for a victim or suspect to be identified by a third party without subjecting that third party to the rigors of the crime scene. An officer with a transceiver could display any necessary images or audio to the third party by directing a partner at the crime scene (also having a transceiver). Still further, the use of the present system would allow a supervisor or forensic specialist to survey a crime scene virtually through a transceiver. This would let them operate more efficiently, spending more time doing analysis and less time traveling to and from various crime scenes.

The law enforcement embodiments of the present invention exploit the flexibility and portability of a wireless system. The transceiver may be a PDA, or alternately a car mounted camera and microphone connected with a PC, or other computing device. An advantage of a car-mounted transceiver is the access to the car's more powerful, renewable battery supply. Further, the central server may feature application-specific software to allow for archiving and dissemination of information such as suspects' files, criminal history, warrant, and booking information.

Medical Field

The system of the present invention may also be used in medical related applications. The portability and flexibility of the present invention could also be used to provide currently unavailable capabilities in the medical field.

For example, with the present system, doctors could download and review a patient's medical history on their transceiver while en route to the hospital. Currently, “on-call” doctors know virtually nothing of a patient's medical history when they are summoned to a hospital or clinic in an emergency. Using the present invention, a doctor could also have instant access to patients' records and visuals of an examination en route to the hospital. Also, a doctor could use the system to communicate with colleagues and get an informed second opinion instantly.

Further, through interactive videoconferencing, the present invention may allow a physician to obtain an interactive second opinion on the patient's condition from another doctor. Use of the system to obtain a second opinion would generally require higher bandwidth than other applications because of the necessity for higher resolution images. In certain circumstances, such as unavailability of other doctors, a doctor may perform the initial diagnosis remotely using a transceiver, with a nurse or other hospital personnel using a second transceiver to view the patient.

Still further, a doctor may “write” a prescription on his transceiver, which may be instantly stored in the central server and transmitted to the patient or his choice of pharmacy. As a further advantage, the doctor could also include a picture of the patient in his transmission to the pharmacy to help reduce the likelihood of fraud.

Still further, a patient's vital signs may be monitored with a transceiver adapted for such use and transmitted to the central server or another transceiver for the doctor's review.

In many of the preceding applications, the doctors' actions can be logged automatically in addition to the patient's condition. This may be useful for performance reviews, and for defending against malpractice claims.

Military Use

The present invention may have embodiments directed at numerous applications for military use. The present system may allow for a command center to coordinate movements of multiple deployed units. In this application, software in the transceivers or central server may enable each transceiver to partition the display, simultaneously displaying video from each other transceiver, and a map, target photograph, or other relevant data. Surveillance units may use the present invention to transmit an audio and video record of a selected target area to the central server for dissemination to other units in the field.

The present invention could also be used by military forces to reduce the risk of miscommunication present in the current predominantly audio only communication. Commanders could use the present invention to conduct a conference with all of the deployed field units simultaneously.

The preceding examples are included to demonstrate specific embodiments of the invention. It should be appreciated by those of skill in the art that the techniques disclosed in the examples which follow represent techniques discovered by the inventor to function well in the practice of the invention, and thus can be considered to constitute preferred modes for its practice. However, it should be understood that the invention is not intended to be limited to the particular forms disclosed. Rather, the different aspects of the disclosed compositions and methods may be utilized in various combinations and/or independently. Thus the invention is not limited to only those combinations shown herein, but rather may include other combinations. Further, those of skill in the art should, in light of the present disclosure, appreciate that many changes can be made in the specific embodiments which are disclosed and still obtain a like or similar result without departing from the spirit and scope of the invention.

The disclosed invention is a wireless conferencing system for interactive rich media communication. The system includes one or more transceivers that acquire, transmit, receive and display audio and video data over a wireless information exchange protocol. Optionally, the system may also include a central server that coordinates the wireless information exchanged among multiple transceivers. Software components may be included to optimize the videoconferencing system for a variety of uses, including judicial, law enforcement, medical, and military applications. Cost savings due to the lack of need for a wire infrastructure and portability of the transceivers are key advantages of the wireless videoconferencing system.

The detailed description of a particular preferred embodiment, set forth above to enable one to implement the invention, is not intended to limit the enumerated claims, but to serve as a particular example thereof. Those skilled in the art should appreciate that they can readily use the concepts and specific embodiments and implementations disclosed as bases for modifying or designing other mattresses and overlay mattresses for carrying out the same purposes of the present invention. Those skilled in the art should also realize that such equivalent mattresses and overlay mattresses do not depart from the spirit and scope of the invention in its broadest form.

Having thus described the present invention, what is claimed as new and desired to be secured by Letters Patent is as follows:

1. A wireless rich media conferencing system including:
a) a first wireless transceiver communicatively coupled to a base station, said first wireless transceiver including means for generating first rich media data, said first rich media data including first real-time video data, and said first transceiver further including means for playing second rich media data, said second rich media data including second real-time video data, and said base station being communicatively coupled to a network; and
b) a second transceiver communicatively coupled to said network, said second transceiver including means for generating said second rich media data, said second rich media data including second real-time video data, and said second transceiver further including means for playing said first rich media data, said first rich media data including first real-time video data.

2. A wireless rich media conferencing system as in claim 1, wherein said base station is comprised of a cellular base station.

3. A wireless rich media conferencing system as in claim 1, wherein said base station is comprised of a local access point.

4. A wireless rich media conferencing system as in claim 1, wherein said second transceiver is comprised of a wireless transceiver.

5. A wireless rich media conferencing system as in claim 1, wherein said second transceiver is comprised of a wired transceiver.

6. A wireless rich media conferencing system as in claim 1, said system further including a means for sending an emergency signal to said first wireless transceiver, and said first wireless transceiver further including means for communicating emergency data to said second transceiver upon receipt of said emergency signal by said first wireless transceiver.

7. A wireless rich media conferencing system as in claim 1, wherein said second transceiver is comprised of a wired transceiver.

8. A wireless rich media conferencing system, as in claim 1, for facilitating a process, said system further including means for displaying documentation related to said process on said first wireless transceiver and on said second transceiver.

9. A wireless rich media conferencing system, as in claim 8, for facilitating a process, said system further including means for displaying documentation related to said process on said first wireless transceiver and on said second transceiver.

10. A wireless rich media conferencing system as in claim 9, said system further including means for converting textual data to speech data and means for audibly playing such speech data on said first wireless transceiver and on said second transceiver.

11. A wireless rich media conferencing system as in claim 1, said system further including arraignment means for performing an interactive real-time remote arraignment.

12. A wireless rich media conferencing system as in claim 1, said system further including deposition means for performing an interactive real-time remote deposition.

13. A wireless rich media conferencing system as in claim 1, said system further including law enforcement monitoring means for performing a interactive real-time law enforcement monitoring.

14. A wireless rich media conferencing system as in claim 1, said system further including crime scene investigation means for performing an interactive real-time crime scene investigation.

15. A wireless rich media conferencing system as in claim 1, said system further including medical examination means for performing an interactive real-time remote medical examination.

16. A wireless rich media conferencing system as in claim 15, said system further including means for a doctor to generate a prescription and means for transmitting the prescription to a designated recipient.

17. A wireless rich media conferencing system as in claim 1, said system further including medical procedure means for interactively facilitating performance, in real-time, of a remote medical procedure.

18. A wireless rich media conferencing system as in claim 1, said system further including military communication means for facilitating interactive real-time remote communications between military personnel.

19. A method for wireless rich media conferencing using a wireless rich media conferencing system as in claim 1, said method comprising steps of
(a) generating first rich media data using said first wireless transceiver, said first rich media data including first real-time video data, and
(b) playing second rich media data using said first wireless transceiver, said second rich media data including second real-time video data, and
(c) generating said second rich media data using said second transceiver, said second rich media data including second real-time video data, and
(d) playing said first rich media data using said second transceiver, said first rich media data including first real-time video data.

20. A method for wireless rich media conferencing using a wireless rich media conferencing system as in claim 8, said method comprising steps of
(a) generating first rich media data using said first wireless transceiver, said first rich media data including first real-time video data, and
(b) playing second rich media data using said first wireless transceiver, said second rich media data including second real-time video data, and
(c) generating said second rich media data using said second transceiver, said second rich media data including second real-time video data, and
(d) playing said first rich media data using said second transceiver, said first rich media data including first real-time video data.
